(19) United States
(12) Patent Application Publication
(10) Pub. No.: US 2015/0272223 A1
(43) Pub. Date: Oct. 1, 2015

(54) SYSTEMS AND METHODS FOR PROVIDING BATTERY VOLTAGE INDICATION IN AN ELECTRONIC VAPOR DEVICE

(71) Applicants: Aaron Arye WEIGENSBERG, Modiin (IL); Bernard JUSTER, Netanya (IL); Isaac WEIGENSBERG, Tekoa (IL)

(72) Inventors: Aaron Arye WEIGENSBERG, Modiin (IL); Bernard JUSTER, Netanya (IL); Isaac WEIGENSBERG, Tekoa (IL)

(21) Appl. No.: 14/671,090

(22) Filed: Mar. 27, 2015

Related U.S. Application Data
(60) Provisional application No. 61/971,815, filed on Mar. 28, 2014.

(51) Int. Cl. A24F 47/00; G08B 7/06; G08B 21/18

(52) U.S. Cl. CPC A24F 47/008; G08B 21/182; G08B 7/06

(57) ABSTRACT

In an example embodiment, an electronic vapor device includes a cartomizer configured to generate an aerosol, a battery associated with the cartomizer and configured to power the cartomizer and a processor. The processor is configured to determine a charge level of the battery, and drive a warning mechanism to provide at least one indication of the charge level based on the determined charge level.

### CROSS REFERENCE TO RELATED APPLICATION

This application claims priority under 35 U.S.C. §119(e) to U.S. Provisional Application No. 61/971,815, filed on Mar. 28, 2014, the entire content of which is incorporated herein by reference.

### BACKGROUND

An electronic vapor device (which may alternatively be referred to as an electronic vaping device or e-vapor device) is a device that may include a battery portion and a cartomizer portion. The battery portion of the electronic vapor device includes a battery for powering the electronic vapor device and the cartomizer portion generates an aerosol (e.g., a vapor or a mist). When the battery runs out of charge, then the electronic vapor device can no longer generate the aerosol. The adult vaper will then realize that the battery is depleted by the absence of the vapor. In other words, the electronic vapor device stops working when the battery is depleted.

### SUMMARY

In an example embodiment, an electronic vapor device includes a cartomizer configured to generate an aerosol, a battery associated with the cartomizer and configured to power the cartomizer and a processor. The processor is configured to determine a charge level of the battery, and drive a warning mechanism to provide at least one indication of the charge level based on the determined charge level.

In one example embodiment, the warning mechanism includes at least one of a light indicator and a sound indicator.

In one example embodiment, the light indicator is a light emitting diode (“LED”) indicator.

In one example embodiment, the processor is configured to determine an impending depletion of the battery based on the determined charge level of the battery, and drive the warning mechanism such that the at least one indication indicates the impending depletion of the battery.

In one example embodiment, the processor is configured to drive the warning mechanism such that the at least one indication indicates one of an initial low battery warning, a low battery warning and a critically low battery warning, based on the determined charge level.

In one example embodiment, the processor is configured to determine the charge level based on at least one of a voltage measurement method and a Coulomb counting method.

In one example embodiment, the processor is configured to determine a first charge level based on the voltage measurement method and a second charge level based on the Coulomb counting method, and determine the charge level by combining the first and second charge levels using a filter.

In one example embodiment, the electronic vapor device includes a memory for storing and tracking the determined charge level.

In one example embodiment, the cartomizer is configured to store a liquid and the cartomizer includes a heating element configured to generate the aerosol from the liquid.

In one example embodiment, the power is provided to the heating element.

In one example embodiment, the processor is configured to determine the charge level periodically.

In one example embodiment, the processor is further configured to determine whether the charge level is equal to or less than at least one threshold, and drive the warning mechanism to provide the at least one indication if the processor determines that the charge level is equal to or less than the at least one threshold.

In one example embodiment, the processor is further configured to switch a mode of operation of the electronic vapor device based on the determined charge level of the battery.

In one example embodiment, the processor is configured to switch the mode of operation of the electronic vapor device between a normal mode and an economy mode.

In one example embodiment, the processor is configured to reduce or disable one or more functions of the electronic vapor device when the electronic vapor device operates in the economy mode.

In one example embodiment, the processor is configured to simultaneously drive the warning system to provide the at least one indication of the charge level, and switch the mode of operation of the electronic vapor device.

In one example embodiment, a battery portion including the battery and the warning mechanism.

In one example embodiment, the cartomizer and the battery are removably coupled.

In an example embodiment, an electronic vapor device includes a cartomizer configured to generate an aerosol, a battery configured to power the cartomizer and a processor. The processor is configured to determine a charge level of the battery, and switch a mode of operation of the electronic vapor device based the determined charge level of the battery.

In one example embodiment, the processor is configured to determine whether the charge level is less than or equal to one or more thresholds, and switch the mode of operation of the electronic vapor device if the determined charge level is less than or equal to the one or more thresholds.

In one example embodiment, the processor is configured to switch the mode of operation of the electronic vapor device between a normal mode and an economy mode.

In one example embodiment, the processor is configured to reduce or disable one or more functions of the electronic vapor device when the electronic vapor device operates in the economy mode.

In one example embodiment, the cartomizer and the battery are removably detachable.

In an example embodiment, a method of operating an electronic vapor device includes powering a cartomizer of the electronic vapor device to generate an aerosol, determining a charge level of a battery powering the cartomizer, and at least one of (i) providing at least one indication of the charge level and (ii) switching a mode of operation of the electronic vapor device based the determining.

### BRIEF DESCRIPTION OF THE DRAWINGS

The system and method may be better understood with reference to the following drawings and description. Non-limiting example embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a diagram of an electronic vapor device, according to one example embodiment;

FIG. 2 is a diagram of an electronic vapor device, according to one example embodiment;

FIG. 3 is a flow chart diagram illustrating operation of an early warning mechanism in an electronic vapor device, according to one example embodiment; and

FIG. 4 is a flow chart diagram illustrating operation of an early warning mechanism in an electronic vapor device, according to one example embodiment.

### DETAILED DESCRIPTION OF EXAMPLE EMBODIMENTS

Various example embodiments will now be described more fully with reference to the accompanying drawings in which some example embodiments are shown.

While example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements, existing end-user devices and/or post-processing tools (e.g., mobile devices, laptop computers, desktop computers, etc.). Such existing hardware may include one or more Central Processing Units (CPUs), digital signal processors (DSPs), application-specific-integrated-circuits, field programmable gate arrays (FPGAs) computers or the like.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

Note also that the software implemented aspects of example embodiments are typically encoded on some form of tangible (or recording) storage medium or implemented over some type of transmission medium. As disclosed herein, the term “storage medium” may represent one or more devices for storing data, including read only memory (ROM), random access memory (RAM), magnetic RAM, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

Example embodiments describe a system and method for operating an electronic vapor device. The electronic vapor device may include a warning mechanism that notifies the adult vaper when the battery powering the electronic vapor device is running low of charge. In one example embodiment, the warning may be provided in advance of the electronic vapor device running out of power. The warning mechanism may notify the adult vaper via any one of, but not limited to, a light, sound, vibration, or any other feedback for informing the adult vaper of the need to charge and/or replace the battery of the electronic vapor device soon. The detection of the battery depletion may be through voltage measurement and/or coulomb counting. The early warning may provide multiple warnings for potential depletion of the battery. For example, 20% charge left in the battery may trigger an initial warning, 10% charge left in the battery may trigger an indication of a low battery warning, and 3% charge left in the battery may trigger an indication of critically low battery warning. The numerical values (i.e., 20%, 10% and 3%) provided above are used as mere examples. Any other value may be determined for providing the initial warning, the low battery warning, and the critically low battery warning. The values may be determined based on empirical studies.

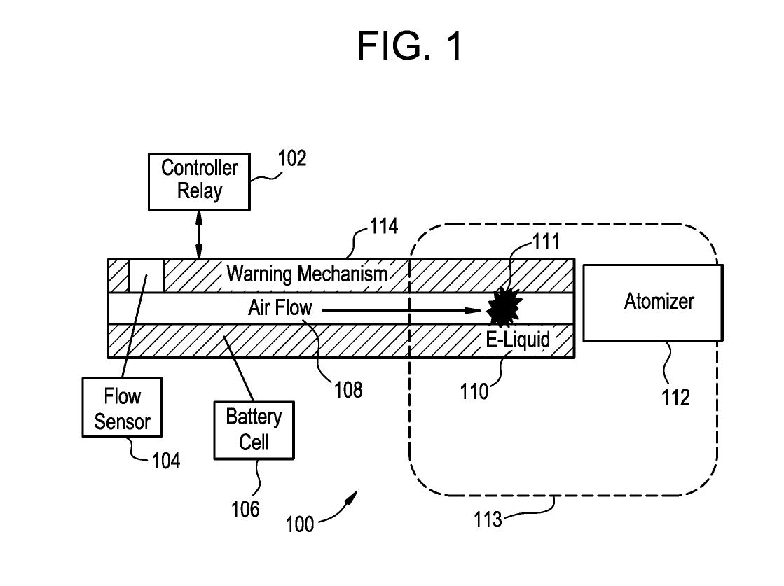

FIG. 1 is a diagram of an electronic vapor device, according to one example embodiment. As shown in FIG. 1, an electronic vapor device 100 produces an aerosol by turning an e-liquid 110 into a mist with an atomizer 112 (alternatively a vaporizer may be used instead of the atomizer 112 for turning the e-liquid 110 into a vapor). In one example embodiment, the e-liquid 110 may be stored in a liquid container (not shown). The cartomizer 113 may include the atomizer 112 and the e-liquid 110. The cartomizer 113 may also be referred to as a cartridge throughout this disclosure and may be disposable. The e-liquid 110 may have a high viscosity at room temperature to enable longer shelf-life and reduce leakages; however, this high viscosity may reduce the atomization (or alternatively, vaporization) rate.

In one example embodiment, the e-liquid 110 is atomized via air flow 108, generated by the inhalation of an adult vaper. In one example embodiment and in order to reduce the viscosity, to a level enabling atomization (or alternatively, vaporization if a vaporizer instead of an atomizer is used in the electronic vapor device 100), external heat may be applied through the heating element 111, which may include a heating coil and a wick (not shown) that is soaked in or includes a portion of the e-Liquid 110. In other words, the heating element 111 may be a coil in one example embodiment that wraps around the wick in order to heat the liquid on the wick. Local viscosity may be reduced via heating, while inhalation occurs, enabling atomization or vaporization in the inhalation-generated flow of air 108.

The e-Liquid 110 may be heated via an electric current flowing through the heating element 111 and may then be atomized and evaporated through the electronic vapor device and may contain tastes and aromas that create a vaping sensation. The controller 102 may be activated due to air flow 108 (from the inhaled air) passing through a flow sensor 104. The flow sensor 104 may be activated by a pressure drop across the flow sensor 104 and may directly switch a battery cell 106 (hereinafter, the battery cell 106 may be referred to as the battery 106) power on, or be used as an input for the controller 102 that then switches the battery 106 current on.

Although illustrated as separate from the electronic vapor device 100, the controller 102 and the battery 106 may be a part of the electronic vapor device 100. The battery 106 may be a separate/removable assembly. The battery 106 may include one or more electronic chips enabling the control and communication of the battery 106. The battery 106 may connect with the cartomizer 113, which may be replaceable/changeable (e.g. when a new/different e-liquid is desired).

The electronic vapor device 100 may include two parts. The first part may be referred to as the battery or battery portion (i.e. battery enclosure), which includes the battery 106, the air flow sensor 104 and the controller 102. The second part is the cartridge (i.e. cartomizer 113), which includes the e-liquid 110 for aerosol (mist or vapor) and flavor generation.

In some example embodiments, there may be more or fewer parts in the electronic vapor device 100. In one example embodiment, the battery portion and the cartridge may be connected by metal connectors. An airflow tube of the battery enclosure and an airflow tube of the cartridge may enable the adult vaper to puff through the electronic vapor device 100 and activate the airflow sensor 104 inside the battery portion. This may trigger the controller 102 and cause the coil inside the cartridge to get hot, evaporate the e-liquid 110 that is in the cartridge and create vapor.

In one example embodiment, while not shown in FIG. 1, the electronic vapor device 100 may include a memory for storing information, such as voltage measurements or battery charge levels. This information may be used for notifying the adult vaper when the battery charge level is nearing depletion.

A warning mechanism 114 may be part of the battery portion or the cartomizer portion. The warning mechanism 114 may be a light, such as a light emitting diode (“LED”) or other light indicator that can notify an adult vaper of the battery charge level. In one example embodiment, there may be different types of lights to indicate the battery level. For example, different colors may indicate the depletion of the battery charge level. In one example embodiment, a yellow light would indicate 20% of the battery charge remaining, while an orange light would indicate 10% of the battery charge remaining, and a red light could indicate 3% of the battery charge remaining. The above described colors and remaining amounts of battery charge are examples for illustrative purposes only. Any other type of indicator indicating any other specified amount of remaining battery charge may be utilized as well.

In one example embodiment, a blinking light may also be used to indicate the amount of remaining battery charge. The blinking may increase in frequency as the depletion of the battery charge is approached.

In one example embodiment, the warning mechanism 114 may be a sound (e.g. beep), vibration, or any other audiovisual or tactile indication. The frequency of the sound/vibration may indicate how soon the battery may be depleted.

In one example embodiment, the warning mechanism 114 may be the LED at a tip of the electronic vapor device 100 that lights during use.

In one example embodiment, there may be multiple thresholds that indicate a low or depleting battery charge. In the example described above, there may be three thresholds (a yellow light would indicate 20% of the battery charge remaining, while an orange light would indicate 10% of the battery charge remaining, and a red light could indicate 3% of the battery charge remaining). In one example embodiment, there may be two threshold levels for “Low Battery” and “Critically Low Battery.”

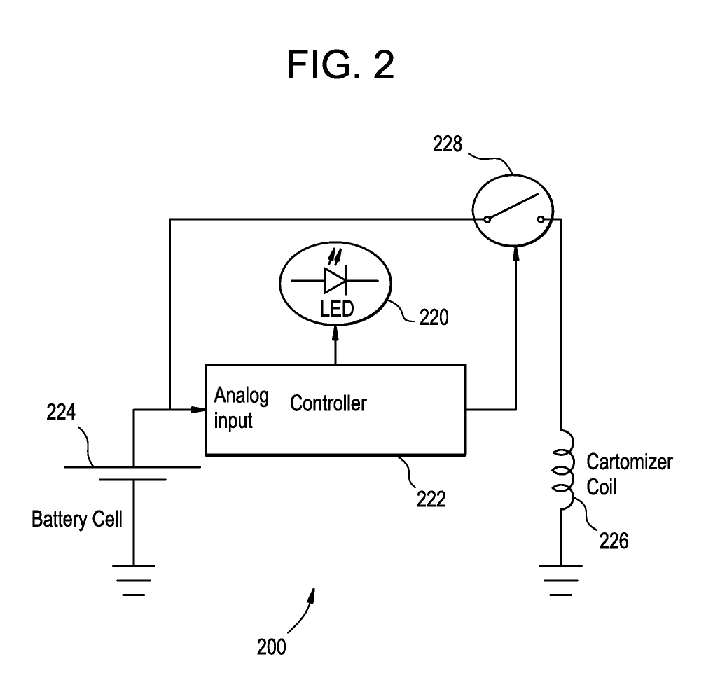

FIG. 2 is a diagram of an electronic vapor device, according to one example embodiment. As shown in FIG. 2, the electronic vapor device 200 (which may be the same as the electronic vapor device 100 or a modified version of the electronic vapor device 100) includes a light emitting diode (“LED”) warning mechanism 220 and a controller 222. In particular, the LED warning mechanism 220 and the controller 222 may be used as the warning mechanism 114 shown in FIG. 1. The battery cell 224 (which hereinafter may be referred to as the battery 224) is coupled with the controller 222, which is coupled with the LED warning mechanism 220. The controller 222 may monitor and track the charge level of the battery 224, as will be further described below.

In one example embodiment and in addition to providing an indication of the charge level of the battery 224, the LED warning mechanism may also be used to provide an indication of a puff or inhalation by the adult vaper of the electronic vapor device 100/200.

In one example embodiment, the determination of the low level of battery charge may not only be communicated to the adult vaper of the electronic vapor device 200, but the operation of the electronic vapor device 200 may be modified. For example, the electronic vapor device 200 may switch from operating in a normal mode to operating in a “low power” or “economy” mode, in which less power is applied to the cartomizer 226 while inhaling. Likewise, the puff length may be limited or other non-essential functions of the electronic vapor device 200 may be shut off in a “low power” mode. In one example embodiment, the limiting or shutting off one or more functions of the electronic vapor device 200 may be done via the switch 228. These actions may either be “hard-coded” into a set of computer-readable instructions stored in a memory associated with the controller 222, such that when executed by the controller 222, cause the controller 222 to perform the above-described functions. Alternatively, the set of actions may be configurable by the adult vaper, depending on the implementation of the electronic vapor device 200.

In one example embodiment, a charge state of the battery 224 may be determined by voltage measurements and/or Coulomb counting. In the example embodiment shown in FIG. 2, the battery 224 is connected to an analog input of the controller 222 for direct measurement by the controller 222. In alternative example embodiment, there may be a separate detector for measuring voltage and/or charge. Since the voltage versus percent charge curve is non-linear, when the voltage starts to significantly drop, the percent charge left may already be very low.

In one example embodiment, Coulomb counting may be used to determine the charge state of the battery 224. Coulomb counting measures the actual milliamp-hours (or amp-hours or other measurement) of the battery 224. The total capacity of the battery 224 may be known and with each puff and usage of the electronic vapor device 200, that amount may be reduced. In other words, the actual milliamp-hours are discounted from the battery's total capacity, thus keeping track of what percentage charge is left in the battery 224. Unlike other applications where dedicated current measurement circuitry is required, in the example embodiment of an electronic vapor device 200 where the resistance of the cartomizer 226 is known, the current may be easily determined. In one example embodiment, the current may be determined by dividing the battery voltage by the coil resistance.

In one example embodiment, the current square wave generated by the smoking puffs may also be integrated. In one example embodiment, the capacity of the battery 224 may need to be adjusted and accounted for because the capacity of the battery 224 may decrease over time.

In one example embodiment, the battery charge level determined using the voltage measurement and Coulomb counting methods may be combined together via a Kalman filter algorithm to provide an improved determination of the charge state of the battery 224.

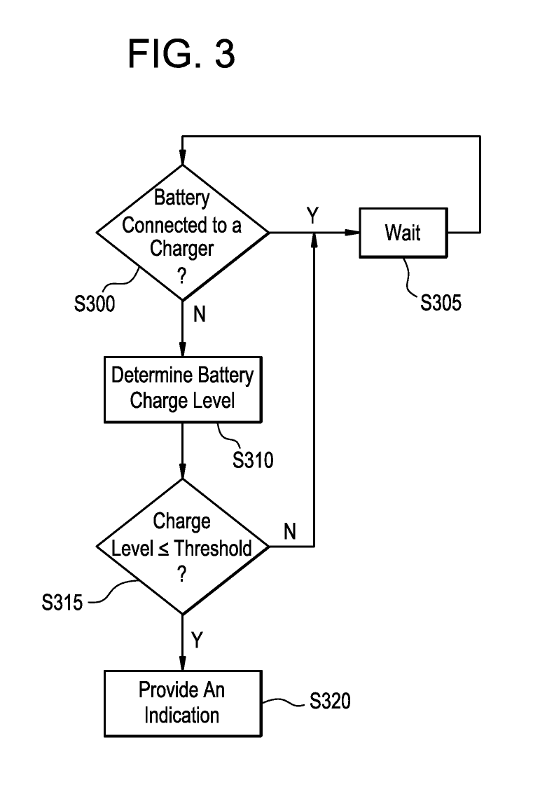

FIG. 3 is a flow chart diagram illustrating operation of an early warning mechanism in an electronic vapor device, according to one example embodiment. With reference to FIG. 2 and FIG. 3, at S300, the controller 222 may determine whether the battery 224 is connected to a battery charger or not. If at S300, the controller 222 determines that the battery 224 is connected to a charger, then the process moves to S305, where the controller 222 waits for a period of time before performing S300 again. In one example embodiment, the period of time is determined based on empirical studies.

If at S300, the controller 222 determines that the battery 224 is not connected to a battery charger, then at S310, the controller 222 determines the amount of battery charge of the battery 224 (i.e., determines a charge level of the battery 224), as described above.

At S315, the controller 222 determines whether the determined charge level of the battery 224 is less than (or alternatively, less than or equal to) a threshold. The threshold may be any one of the thresholds described above. If at S315, the controller 222 determines that the charge level of the battery 224 is less than the threshold, then at S320, the controller 222, via the LED warning mechanism 220 for example, provides an indication that the battery charge remaining in the battery 224 is low. The indication may be one or more of the different type of indications described above.

If at S315, the controller 222 determines that the charge level of the battery 224 is greater than the threshold, the process proceeds to S305, as described above.

In one example embodiment as also described above, there may be more than one threshold to compare the battery charge with, in order to provide the appropriate indication (e.g., “low battery”, “critically low battery”, etc., indications as described above). Accordingly when there are multiple thresholds, the controller 315 may perform S315 and S320 for each threshold, where the indication provided at S320 corresponds to the threshold with which the charge level of the battery 224 is compared. For example, if the threshold is 10%, then at S320 the indication is the “low battery warning,” as described above. However, if the threshold is 3%, then at S320 the indication is the “critically low battery waning,”, as described above.

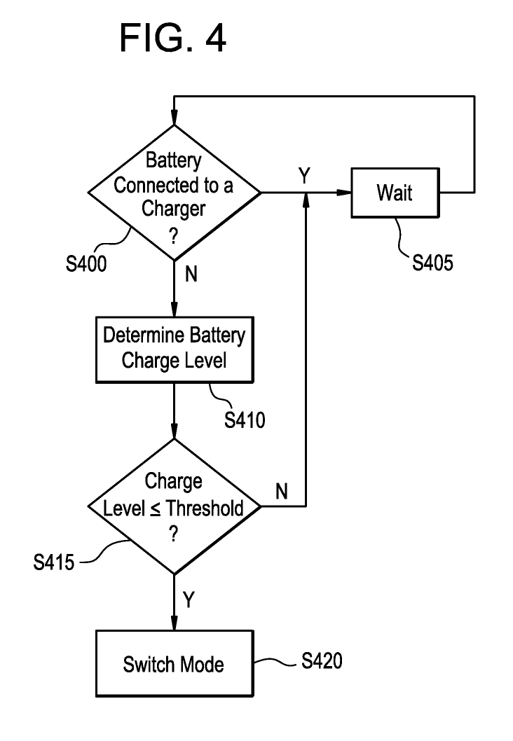

FIG. 4 is a flow chart diagram illustrating operation of an early warning mechanism in an electronic vapor device, according to one example embodiment. S400 to S415 of FIG. 4 are the same as S300 to S315 of FIG. 3, respectively. Therefore, for the sake of brevity, S400 to S415 will not be described in greater detail.

At S420 and upon determining that the charge level in the battery 224 is less than the threshold, the controller 222 switches the mode of operation of the electronic vapor device 200 from the “normal mode” into the “economy mode”, as described above.

In one example embodiment, the controller may simultaneously perform the function described with reference to S320 in FIG. 3 and the function described with reference to S420 in FIG. 4. In other words, upon determining that the charge level remaining in the batter 224 is less than (or alternatively less than or equal to) the threshold, the controller 222 may provide the indication at S320 and switch the mode of operation of the electronic vapor device 200 from the “normal mode” to the “economy mode”.

Variations of the example embodiments are not to be regarded as a departure from the spirit and scope of the example embodiments, and all such variations as would be apparent to one skilled in the art are intended to be included within the scope of this disclosure.

We claim:

1. An electronic vapor device comprising:
a cartomizer configured to generate an aerosol;
a battery associated with the cartomizer and configured to power the cartomizer; and
a processor configured to,
determine a charge level of the battery, and
drive a warning mechanism to provide at least one indication of the charge level based on the determined charge level.

2. The electronic vapor device of claim 1, wherein the warning mechanism includes at least one of a light indicator and a sound indicator.

3. The electronic vapor device of claim 2, wherein the light indicator is a light emitting diode (“LED”) indicator.

4. The electronic vapor device of claim 2, wherein the processor is configured to,
determine an impending depletion of the battery based on the determined charge level of the battery, and
drive the warning mechanism such that the at least one indication indicates the impending depletion of the battery.

5. The electronic vapor device of claim 4, wherein the processor is configured to drive the warning mechanism such that the at least one indication indicates one of an initial low battery warning, a low battery warning and a critically low battery warning, based on the determined charge level.

6. The electronic vapor device of claim 1, wherein the processor is configured to determine the charge level based on at least one of a voltage measurement method and a Coulomb counting method.

7. The electronic vapor device of claim 6, wherein the processor is configured to,
determine a first charge level based on the voltage measurement method and a second charge level based on the Coulomb counting method, and
determine the charge level by combining the first and second charge levels using a filter.

8. The electronic vapor device of claim 1, further comprising:
a memory for storing and tracking the determined charge level.

9. The electronic vapor device of claim 1, wherein
the cartomizer is configured to store a liquid; and
the cartomizer includes a heating element configured to generate the aerosol from the liquid.

10. The electronic vapor device of claim 9, wherein the power is provided to the heating element.

11. The electronic vapor device of claim 1, wherein the processor is configured to determine the charge level periodically.

12. The electronic vapor device of claim 1, wherein the processor is further configured to,
determine whether the charge level is equal to or less than at least one threshold, and
drive the warning mechanism to provide the at least one indication if the processor determines that the charge level is equal to or less than the at least one threshold.

13. The electronic vapor device of claim 1, wherein the processor is further configured to switch a mode of operation of the electronic vapor device based on the determined charge level of the battery.

14. The electronic vapor device of claim 13, wherein the processor is configured to switch the mode of operation of the electronic vapor device between a normal mode and an economy mode.

15. The electronic vapor device of claim 14, wherein the processor is configured to reduce or disable one or more functions of the electronic vapor device when the electronic vapor device operates in the economy mode.

16. The electronic vapor device of claim 13, wherein the processor is configured to simultaneously,
drive the warning system to provide the at least one indication of the charge level, and
switch the mode of operation of the electronic vapor device.

17. The electronic vapor device of claim 1, further comprising:
a battery portion including the battery and the warning mechanism.

18. The electronic vapor device of claim 1, wherein the cartomizer and the battery are removably coupled.

19. An electronic vapor device, comprising:
a cartomizer configured to generate an aerosol;
a battery configured to power the cartomizer; and
a processor configured to,
determine a charge level of the battery, and
switch a mode of operation of the electronic vapor device based the determined charge level of the battery.

20. The electronic vapor device of claim 19, wherein the processor is configured to,
determine whether the charge level is less than or equal to one or more thresholds, and
switch the mode of operation of the electronic vapor device if the determined charge level is less than or equal to the one or more thresholds.

21. The electronic vapor device of claim 19, wherein the processor is configured to switch the mode of operation of the electronic vapor device between a normal mode and an economy mode.

22. The electronic vapor device of claim 21, wherein the processor is configured to reduce or disable one or more functions of the electronic vapor device when the electronic vapor device operates in the economy mode.

23. The electronic vapor device of claim 22, wherein the cartomizer and the battery are removably detachable.

24. A method of operating an electronic vapor device, the method comprising:
powering a cartomizer of the electronic vapor device to generate an aerosol;
determining a charge level of a battery powering the cartomizer, and
at least one of (i) providing at least one indication of the charge level and (ii) switching a mode of operation of the electronic vapor device based the determining.
